(19) United States
(12) Patent Application Publication
(10) Pub. No.: US 2023/0153365 A1
(43) Pub. Date: May 18, 2023

(54) METHODS AND SYSTEMS FOR DETERMINING USER INTENTS AND SENTIMENTS

(71) Applicant: Safe Kids LLC, Vienna, VA (US)

(72) Inventors: Abbas Valliani, Vienna, VA (US); Elizabeth Sweigart, Houston, TX (US); Shahzad Badar, Ashburn, VA (US); Atif Bhanjee, Houston, TX (US)

(21) Appl. No.: 17/525,788

(22) Filed: Nov. 12, 2021

(51) Int. Cl. G06F 16/9535; G06F 40/40; G06K 9/62; G06N 20/20

(52) U.S. Cl. CPC G06F 16/9535; G06F 40/40; G06K 9/6256; G06N 20/20

(57) ABSTRACT

The present disclosure is directed to determining user intents and sentiments. In particular, the methods and systems of the present disclosure may: receive data indicating a hyperlinked object invoked by a user in response to the hyperlinked object being provided to the user as part of a plurality of search results determined to be responsive to a query of the user; and determine, based at least in part on one or more machine learning (ML) models and the data indicating the hyperlinked object, at least one of a subjective intent or sentiment of the user associated with the query.

### FIELD

The present disclosure relates generally to machine learning. More particularly, the present disclosure relates to methods and systems for determining user intents and sentiments.

### BACKGROUND

Computing devices (e.g., desktop computers, laptop computers, tablet computers, set-top devices, smartphones, wearable computing devices, and/or the like) are ubiquitous in modern society. They may support communications between their users, provide their users with entertainment, information about their environments, current events, the world at large, and/or the like. For certain users (e.g., children, employees, and/or the like) there may be a need and/or desire on the part of other individuals or organizations (e.g., parents, employers, and/or the like) to supervise, monitor, and/or the like content provided, displayed, and/or the like to the users by such devices.

### SUMMARY

Aspects and advantages of embodiments of the present disclosure will be set forth in part in the following description, or may be learned from the description, or may be learned through practice of the embodiments.

One example aspect of the present disclosure is directed to a method. The method may include receiving, by one or more computing devices, data indicating a hyperlinked object invoked by a user in response to the hyperlinked object being provided to the user as part of a plurality of search results determined to be responsive to a query of the user. The method may also include determining, by the computing device(s) and based at least in part on one or more machine learning (ML) models and the data indicating the hyperlinked object, at least one of a subjective intent or sentiment of the user associated with the query.

Another example aspect of the present disclosure is directed to a system. The system may include one or more processors, and a memory storing instructions that when executed by the processor(s) cause the system to perform operations. The operations may include receiving data indicating a plurality of search results determined to be responsive to one or more queries comprising one or more parameters associated with one or more particular human intents or sentiments. The operations may also include generating, based at least in part on said received data, one or more machine learning (ML) models configured to determine, from amongst the particular human intent(s) or sentiment(s) and based at least in part on data indicating a hyperlinked object invoked by a user in response to the hyperlinked object being provided to the user as part of a plurality of search results determined to be responsive to a query of the user, at least one of a subjective intent or sentiment of the user in making the query.

A further example aspect of the present disclosure is directed to one or more non-transitory computer-readable media comprising instructions that when executed by one or more computing devices cause the computing device(s) to perform operations. The operations may include receiving data indicating a plurality of search results determined to be responsive to one or more queries. The one or more queries may comprise one or more parameters associated with one or more particular human intents or sentiments and may be executed with respect to at least one of: multiple different and distinct locations, multiple different and distinct languages, or multiple different and distinct search engines. The operations may also include generating, based at least in part on said received data, one or more machine learning (ML) models configured to determine, from amongst the particular human intent(s) or sentiment(s) and based at least in part on data indicating a hyperlinked object invoked by a user in response to the hyperlinked object being provided to the user as part of a plurality of search results determined to be responsive to a query of the user, at least one of a subjective intent or sentiment of the user in making the query.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in this specification, which makes reference to the appended figures, in which:

FIG. 1 depicts an example computing environment according to example embodiments of the present disclosure;

FIGS. 2A and 2B depict an example event sequence according to example embodiments of the present disclosure;

FIGS. 3 and 4 depict example system architectures according to example embodiments of the present disclosure;

FIGS. 5A and 5B depict example interfaces according to example embodiments of the present disclosure; and

FIGS. 6 and 7 depict example methods according to example embodiments of the present disclosure.

### DETAILED DESCRIPTION

With reference now to the Figures, example embodiments of the present disclosure will be discussed in further detail.

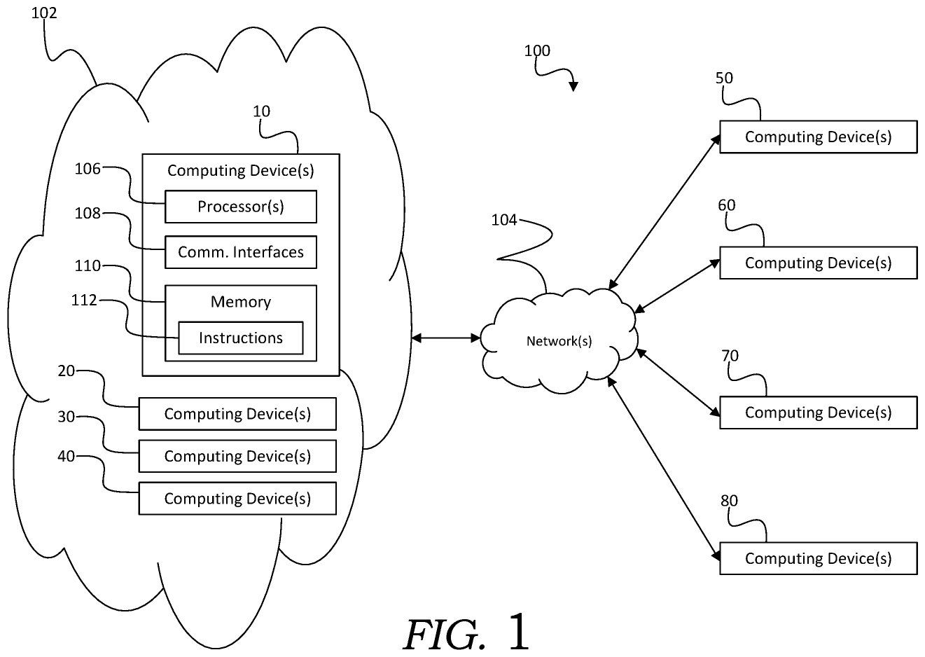

FIG. 1 depicts an example computing environment according to example embodiments of the present disclosure.

Referring to FIG. 1, environment 100 may include one or more computing devices (e.g., one or more desktop computers, laptop computers, set-top devices, tablet computers, mobile devices, smartphones, wearable devices, servers, and/or the like). For example, environment 100 may include computing devices 10, 20, 30, 40, 50, 60, 70, and/or 80, any one of which may include one or more associated and/or component computing devices (e.g., a mobile device and an associated wearable device, one or more associated servers, and/or the like). Environment 100 may also include one or more networks, for example, network(s) 102 and/or 104 (e.g., one or more wired networks, wireless networks, and/or the like). Network(s) 102 may interface computing device(s) 10, 20, 30, and/or 40, with one another and/or computing device(s) 50, 60, 70, and/or 80 (e.g., via network(s) 104, and/or the like).

Computing device(s) 10 may include one or more processor(s) 106, one or more communication interfaces 108, and memory 110 (e.g., one or more hardware components for storing executable instructions, data, and/or the like). Communication interface(s) 108 may enable computing device(s) 10 to communicate with computing device(s) 20, 30, 40, 50, 60, 70, and/or 80 (e.g., via network(s) 102, 104, and/or the like). Memory 110 may include (e.g., store, and/or the like) instructions 112. When executed by processor(s) 106, instructions 112 may cause computing device(s) 10 to perform one or more operations, functions, and/or the like described herein. It will be appreciated that computing device(s) 20, 30, 40, 50, 60, 70, and/or 80 may include one or more of the components described above with respect to computing device(s) 10.

Unless explicitly indicated otherwise, the operations, functions, and/or the like described herein may be performed by computing device(s) 10, 20, 30, 40, 50, 60, 70, and/or 80 (e.g., by computing device(s) 10, 20, 30, 40, 50, 60, 70, or 80, by any combination of one or more of computing device(s) 10, 20, 30, 40, 50, 60, 70, and/or 80, and/or the like).

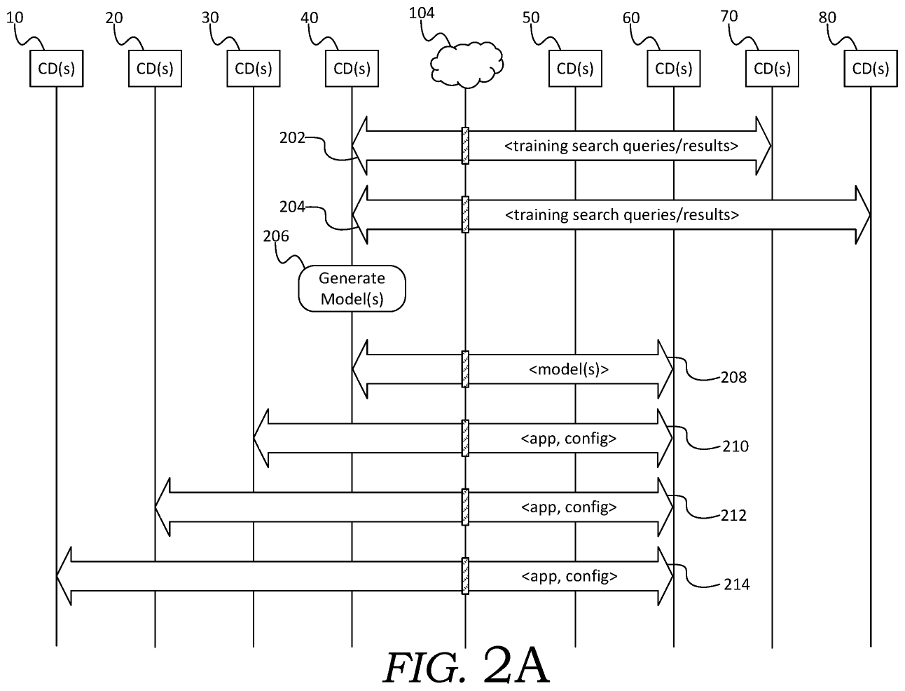

FIGS. 2A and 2B depict an example event sequence according to example embodiments of the present disclosure.

Referring to FIG. 2A, at (202), computing device(s) 40 (e.g., one or more computing devices associated with one or more developers of one or more machine learning (ML) models, and/or the like) may generate and communicate (e.g., via network(s) 104 (as indicated by the cross-hatched box over the line extending downward from network(s) 104), and/or the like) data (e.g., indicating one or more search parameters, criteria, and/or the like) associated with one or more search queries (e.g., training queries, and/or the like) to computing device(s) 70 (e.g., one or more computing devices associated with an internet search engine, provider, and/or the like), which may receive said data and may generate and communicate responsive data (e.g., indicating one or more search results determined to be responsive to the one or more search queries, and/or the like) to computing device(s) 40, which may receive, store, and/or the like said responsive data.

Similarly, at (204), computing device(s) 40 may generate and communicate data associated with one or more search queries (e.g., the same, similar, or different and distinct search queries, and/or the like) to computing device(s) 80 (e.g., one or more computing devices associated with a different and distinct internet search engine, provider, and/or the like), which may receive said data and may generate and communicate responsive data to computing device(s) 40, which may receive, store, and/or the like said responsive data.

It will be appreciated that the data communicated and/or received (e.g., from computing device(s) 70, 80, and/or the like) by computing device(s) 40 may comprise a corpus for generating, training, updating, and/or the like one or more ML models. In some embodiments, such a corpus of training data may comprise a plurality of objects provided as part of the data indicating the search results (e.g., hyperlinked objects, and/or the like). For example, such data may include titles of webpages associated with the search results, hashtags, captions, and/or the like associated with one or more images, videos, and/or the like associated with the search results, and/or the like.

In some embodiments, the search parameter(s) (e.g., keywords, terms, images, and/or the like) may be associated with one or more particular human intents, sentiments, and/or the like designated by a content supervisor (e.g., a parent, employer, and/or the like) for identification. For example, the search parameter(s) may be related to violence, gambling, sexually explicit content, adult content, sexting, bullying, suicidal ideation, self-harm, anxiety, depression, psychological concerns, eating disorders, illicit drugs, alcohol, addictive behaviors, and/or the like. In some of such embodiments, the search parameter(s) may comprise natural language corresponding to one or more human inquiries objectively indicating the particular human intent(s), sentiment(s), and/or the like (e.g., “How do I take my own life?”, “Where can you buy pot?”, and/or the like). In some embodiments, the one or more search queries may be executed with respect to multiple different and distinct locations, languages, search engines, and/or the like.

At (206), computing device(s) 40 may generate, train, update, and/or the like (e.g., based at least in part on the corpus of training data, and/or the like) one or more ML models configured to determine (e.g., from amongst the particular human intent(s), sentiment(s), and/or the like designated by the content supervisor, and/or the like) a subjective intent, sentiment, and/or the like of a user in making a query, and/or the like. For example, such ML model(s) may be configured to determine a user's subjective intent, sentiment, and/or the like based at least in part on data indicating an object (e.g., a hyperlinked object, and/or the like) invoked by the user, e.g., in response to the object being provided to the user as part of a plurality of search results determined to be responsive to their query, and/or the like.

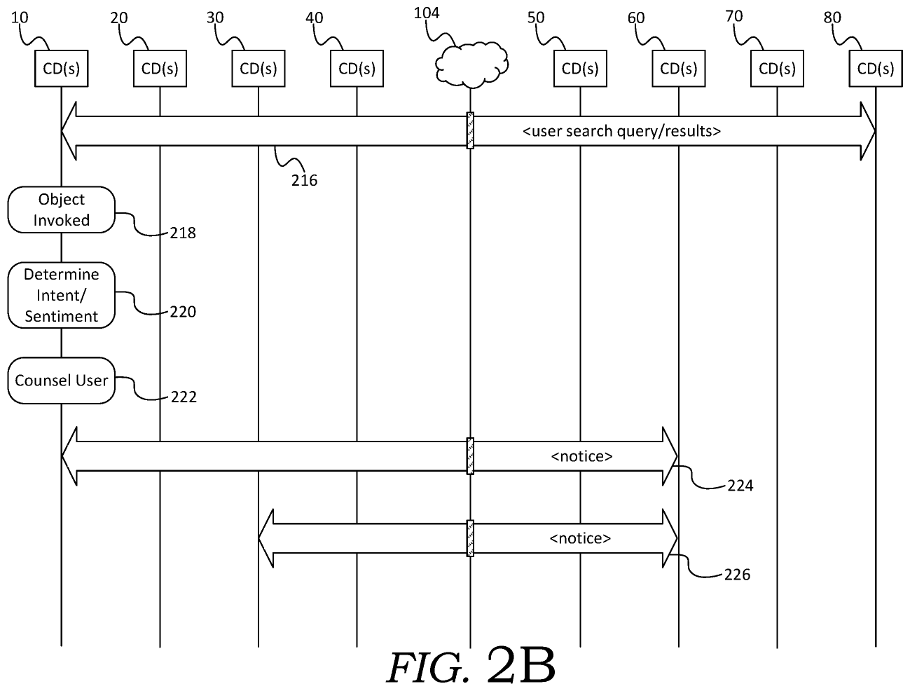

In some embodiments, the ML model(s) may include a common (e.g., the same, and/or the like) model configured to determine the subjective intent, sentiment, and/or the like of the user from amongst the particular human intent(s), sentiment(s), and/or the like designated by the content supervisor, and/or the like. For example, referring to FIG. 3, output from pre-ML-model processing 302 may be communicated to a common ML model for processing 304, and/or the like, the output of which may be communicated to post-ML-model processing 306, and/or the like.

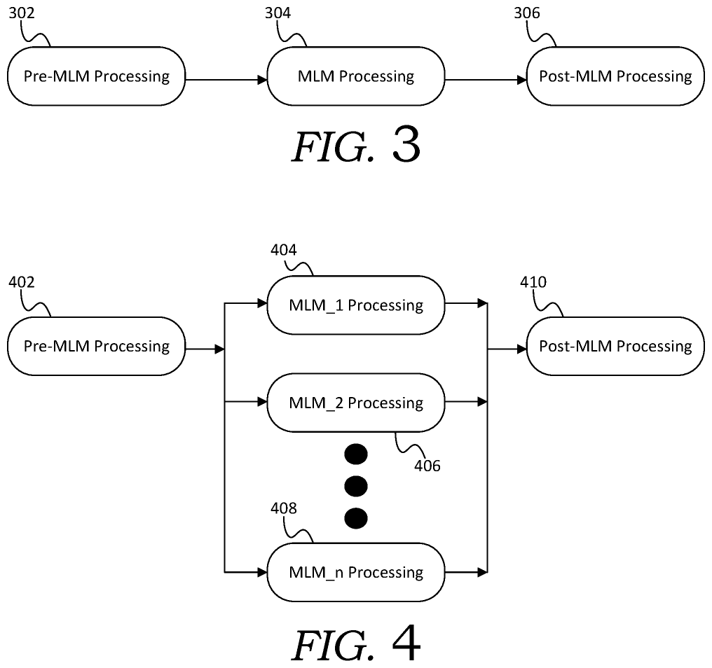

Additionally or alternatively, the ML model(s) may include multiple different and distinct ML models, each of which may be configured to determine a different and distinct intent, sentiment, and/or the like from amongst the particular human intent(s), sentiment(s), and/or the like designated by the content supervisor, and/or the like. For example, referring to FIG. 4, output from pre-ML-model processing 402 may be communicated to multiple different and distinct ML models, and/or the like for separate respective processing 404, 406, 408, and/or the like, the output of each of which may be communicated to post-ML-model processing 410, and/or the like.

In some embodiments, generating, training, updating, and/or the like the ML model(s) may include determining a set (e.g., vocabulary, and/or the like) of unique, closely related, associated, and/or the like units (e.g., words, and/or the like) for the data corpus and determining a numeric representation for each of said units (e.g., based at least in part on frequency of occurrence, and/or the like). In some of such embodiments, such a set of units may be processed by a neural network (e.g., a deep neural network with one or more learning layers, and/or the like). It will be appreciated that the output of such processing may then be calibrated based at least in part on various data sets (e.g., associated with training, testing, and/or the like) to optimize performance, and/or the like.

Returning to FIG. 2A, at (208), data indicating, describing, specifying, and/or the like the ML model(s), one or more aspects thereof, and/or the like may be communicated between computing device(s) 40 and 60 (e.g., one or more servers, and/or the like).

At (210), computing device(s) 30 (e.g., one or more user devices, and/or the like) and computing device(s) 60 may communicate data registering one or more user devices, accounts, and/or the like for content supervision. For example, computing device(s) 10 and/or 20 may be utilized by one or more users (e.g., children, employees, and/or the like) of a user (e.g., parent, employer, and/or the like) utilizing computing device(s) 30, who may register such user device(s) and/or account(s) via a web, application, and/or the like interface provided by computing device(s) 60, and/or the like (e.g., by providing identifying information associated with such user device(s), account(s), and/or the like).

At (212), computing device(s) 20 and 60 may communicate data (e.g., one or more applications, configuration data, machine learning (ML) models, and/or the like), which computing device(s) 20 may receive, store, install, and/or the like. For example, a user (e.g., the parent, employer, and/or the like) may utilize computing device(s) 20 and/or 30 to download, install, and/or the like such data to computing device(s) 20 in order to supervise content provided, displayed, requested, and/or the like by computing device(s) 20, determine one or more activity patterns of the user(s) of computing device(s) 20, and/or the like.

Similarly, at (214), computing device(s) 10 and 60 may communicate data, which computing device(s) 10 may receive, store, install, and/or the like. For example, a user (e.g., the parent, employer, and/or the like) may utilize computing device(s) 10 and/or 30 to download, install, and/or the like such data to computing device(s) 10 in order to supervise content provided, displayed, requested, and/or the like by computing device(s) 10, determine one or more activity patterns of the user(s) of computing device(s) 10, and/or the like.

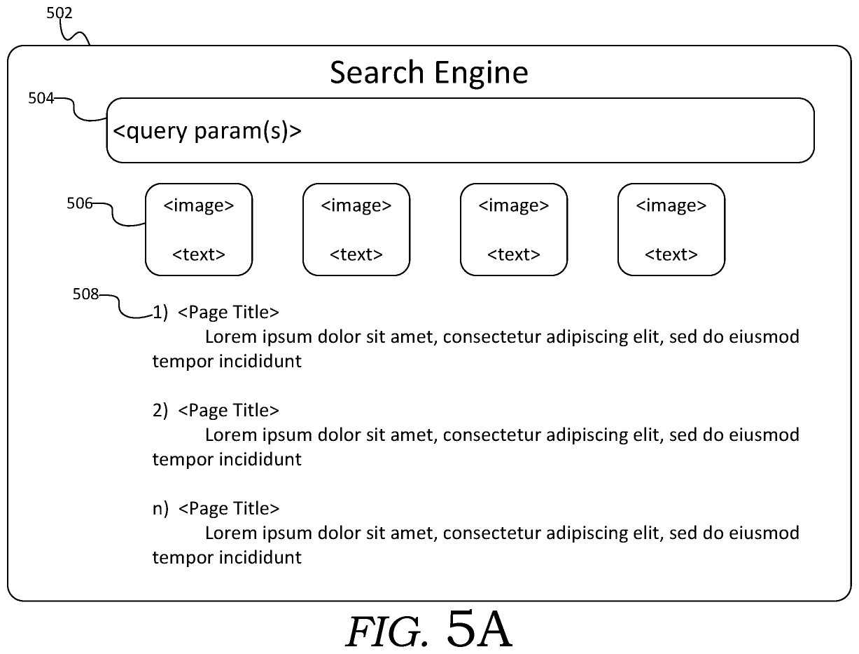

Referring to FIG. 2B, at (216), computing device(s) 10 and 80 may communicate data (e.g., indicating one or more search parameters, criteria, and/or the like) associated with one or more search queries of the user of computing device(s) 10, as well as data indicating one or more search results determined to be responsive to the user's one or more queries, and/or the like. For example, referring to FIG. 5A, computing device(s) 10 may generate (e.g., based at least in part on such communications, and/or the like) data representing graphical user interface (GUI) 502, which may include elements 504 (e.g., corresponding to one or more of the search parameter(s), and/or the like), 506 (e.g., corresponding to one or more images, videos, and/or the like associated with the search result(s), and/or the like), and 508 (e.g., corresponding to one or more titles of one or more linked webpages associated with the search result(s), and/or the like).

Returning to FIG. 2B, at (218), computing device(s) 10 may receive data indicating an object (e.g., a hyperlinked object, interface element, and/or the like) invoked by the user of computing device(s) 10, for example, in response to the object having been provided as part of the search result(s) determined to be responsive to the user's one or more queries, and/or the like. For example, in some embodiments, such an object (e.g., corresponding to one or more of elements 508, and/or the like) may comprise a title of a linked webpage, and/or the like. Additionally or alternatively, the object (e.g., corresponding to one or more of elements 506, and/or the like) may comprise a hashtag, caption, and/or the like associated with one or more images, videos, and/or the like. In some embodiments, the data indicating the object invoked by the user may be received via a web-browser extension configured to generate the data, and/or the like. Additionally or alternatively, the data indicating the object invoked by the user may be received via code configured to generate the data and injected into intercepted network traffic associated with the search result(s), and/or the like.

At (220), computing device(s) 10 may determine (e.g., based at least in part on one or more of the generated, trained, updated, and/or the like ML model(s), data indicating the object invoked by the user of computing device(s) 10, and/or the like) a subjective intent, sentiment, and/or the like of the user of computing device(s) 10 in making the query, and/or the like. In some embodiments, one or more of the ML model(s) may be configured to determine the subjective intent, sentiment, and/or the like of the user based at least in part on a history of one or more objects (e.g., hyperlinked objects, and/or the like) previously invoked by the user, and/or the like, and computing device(s) 10 may determine the subjective intent, sentiment, and/or the like based at least in part on such history, and/or the like. Additionally or alternatively, one or more of the ML model(s) may be configured to determine the subjective intent, sentiment, and/or the like of the user based at least in part on a history of one or more intents, sentiments, and/or the like of the user previously determined based at least in part on the ML model(s), and/or the like, and computing device(s) 10 may determine the subjective intent, sentiment, and/or the like based at least in part on such history, and/or the like.

It will be appreciated that the technology described herein may be combined with one or more other technologies, e.g., to determine the subjective intent, sentiment, and/or the like of the user of computing device(s) 10, and/or the like. For example, the technology described herein may be combined with one or more aspects of the technology described in U.S. Pat. No. 10,949,774, issued Mar. 16, 2021, and entitled “METHODS AND SYSTEMS FOR SUPERVISING DISPLAYED CONTENT,” the disclosure of which is incorporated herein by reference in its entirety.

At (222), responsive to determining that the subjective intent, sentiment, and/or the like of the user of computing device(s) 10 corresponds to a subjective intent, sentiment, and/or the like designated by the content supervisor for identification, computing device(s) 10 may generate data representing a GUI indicating detection of the subjective intent, sentiment, and/or the like and comprising educational material counseling the user with respect to their determined subjective intent, sentiment, and/or the like. For example, referring to FIG. 5B, computing device(s) 10 may generate data representing, updating, modifying, and/or the like GUI 502 to include elements 510 (e.g., obstructing access to, viewing of, and/or the like one or more portions of GUI 502, and/or the like), 512 (e.g., indicating a period of time for which the portion(s) of GUI 502 will continue to be obstructed, and/or the like), and 514 (e.g., comprising educational material, such as a video, and/or the like counseling the user with respect to their determined subjective intent, sentiment, and/or the like). For example, the technology described herein may be combined with one or more aspects of the technology described in U.S. patent application Ser. No. 17/471,129, filed Sep. 9, 2021, and entitled “METHODS AND SYSTEMS FOR INTERACTIVELY COUNSELING A USER WITH RESPECT TO SUPERVISED CONTENT,” the disclosure of which is incorporated herein by reference in its entirety.

Returning to FIG. 2B, at (224), computing device(s) 10 and 60 may communicate data indicating detection of the subjective intent, sentiment, and/or the like of the user of computing device(s) 10, and/or the like. Similarly, at (226), computing device(s) 30 and 60 may communicate data indicating detection of the subjective intent, sentiment, and/or the like of the user of computing device(s) 10, and/or the like.

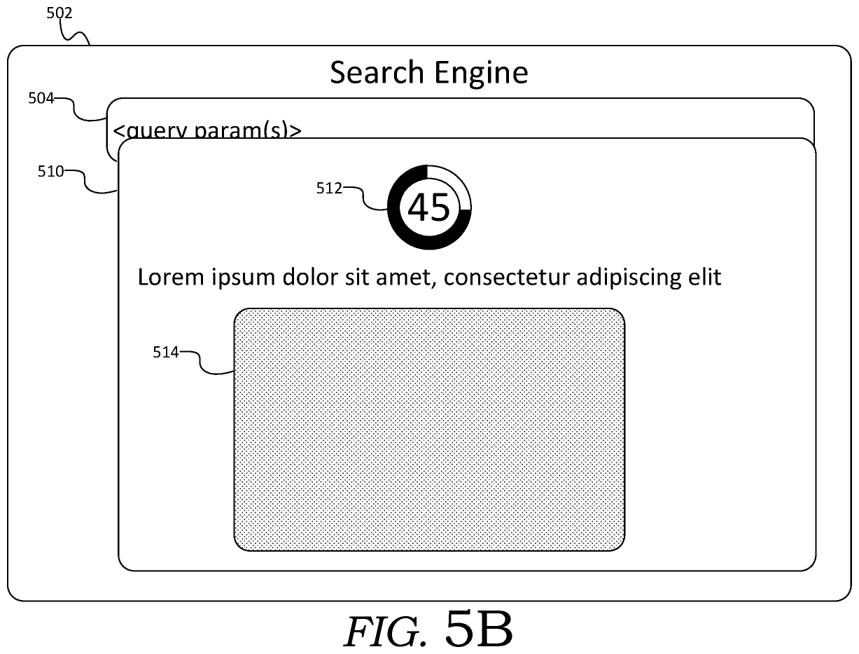

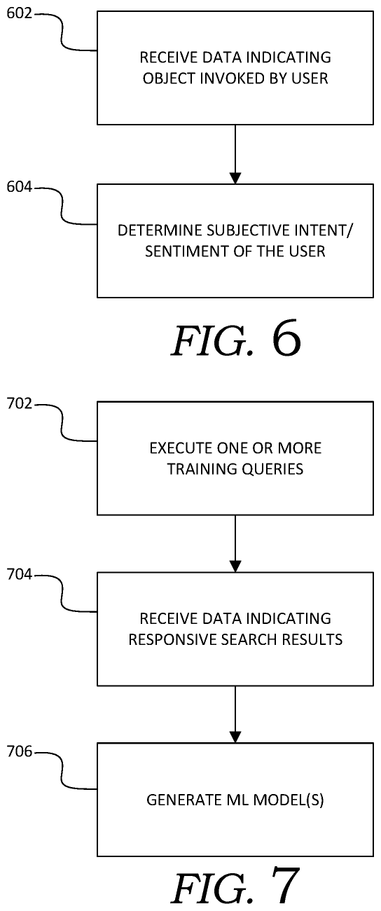

FIGS. 6 and 7 depict example methods according to example embodiments of the present disclosure.

Referring to FIG. 6, at (602), one or more computing device(s) may receive data indicating an object invoked by a user, e.g., in response to the object being provided to the user as part of a plurality of search results determined to be responsive to a query of the user. For example, computing device(s) 10 may receive data indicating its user has invoked an object associated with one or more of element(s) 506, 508, and/or the like.

At (604), the computing device(s) may determine (e.g., based at least in part on one or more ML models, the data indicating the invoked object, and/or the like) a subjective, intent, sentiment, and/or the like of the user, e.g., associated with their query, and/or the like. For example, computing device(s) 10 may determine a subjective intent, sentiment, and/or the like of its user based at least in part on the data received at (602), the ML model(s) generated, trained, updated, and/or the like at (206), and/or the like.

Referring to FIG. 7, at (702), one or more computing device(s) may execute one or more queries comprising one or more parameters associated with one or more particular human intents, sentiments, and/or the like. For example, computing device(s) 40 may execute one or more such queries, e.g., at (202), (204), and/or the like.

At (704), the computing device(s) may receive data indicating search results determined to be responsive to the one or more executed queries. For example, computing device(s) 40 may receive such data, e.g., at (202), (204), and/or the like.

At (706), the computing device(s) may generate, train, update, and/or the like (e.g., based at least in part on the received data indicating the search results, and/or the like) one or more ML models configured to determine (e.g., from amongst the particular human intent(s), sentiment(s), and/or the like) a subjective intent, sentiment, and/or the like of a user in making a query, e.g., based at least in part on data indicating an object invoked by the user in response to the object being provided to the user as part of search results determined to be responsive to the user's query. For example, computing device(s) 40 may generate, train, update, and/or the like such ML model(s), e.g., at (206), and/or the like.

The technology discussed herein makes reference to servers, databases, software applications, and/or other computer-based systems, as well as actions taken and information sent to and/or from such systems. The inherent flexibility of computer-based systems allows for a great variety of possible configurations, combinations, and/or divisions of tasks and/or functionality between and/or among components. For instance, processes discussed herein may be implemented using a single device or component and/or multiple devices or components working in combination. Databases and/or applications may be implemented on a single system and/or distributed across multiple systems. Distributed components may operate sequentially and/or in parallel.

Various connections between elements are discussed in the above description. These connections are general and, unless specified otherwise, may be direct and/or indirect, wired and/or wireless. In this respect, the specification is not intended to be limiting.

The depicted and/or described steps are merely illustrative and may be omitted, combined, and/or performed in an order other than that depicted and/or described; the numbering of depicted steps is merely for ease of reference and does not imply any particular ordering is necessary or preferred.

The functions and/or steps described herein may be embodied in computer-usable data and/or computer-executable instructions, executed by one or more computers and/or other devices to perform one or more functions described herein. Generally, such data and/or instructions include routines, programs, objects, components, data structures, or the like that perform particular tasks and/or implement particular data types when executed by one or more processors of a computer and/or other data-processing device. The computer-executable instructions may be stored on a computer-readable medium such as a hard disk, optical disk, removable storage media, solid-state memory, read-only memory (ROM), random-access memory (RAM), or the like. As will be appreciated, the functionality of such instructions may be combined and/or distributed as desired. In addition, the functionality may be embodied in whole or in part in firmware and/or hardware equivalents, such as integrated circuits, application-specific integrated circuits (ASICs), field-programmable gate arrays (FPGAs), or the like. Particular data structures may be used to more effectively implement one or more aspects of the disclosure, and such data structures are contemplated to be within the scope of computer-executable instructions and/or computer-usable data described herein.

Although not required, one of ordinary skill in the art will appreciate that various aspects described herein may be embodied as a method, system, apparatus, and/or one or more computer-readable media storing computer-executable instructions. Accordingly, aspects may take the form of an entirely hardware embodiment, an entirely software embodiment, an entirely firmware embodiment, and/or an embodiment combining software, hardware, and/or firmware aspects in any combination.

As described herein, the various methods and acts may be operative across one or more computing devices and/or networks. The functionality may be distributed in any manner or may be located in a single computing device (e.g., server, client computer, user device, or the like).

Aspects of the disclosure have been described in terms of illustrative embodiments thereof. Numerous other embodiments, modifications, and/or variations within the scope and spirit of the appended claims may occur to persons of ordinary skill in the art from a review of this disclosure. For example, one of ordinary skill in the art may appreciate that the steps depicted and/or described may be performed in other than the recited order and/or that one or more illustrated steps may be optional and/or combined. Any and all features in the following claims may be combined and/or rearranged in any way possible.

While the present subject matter has been described in detail with respect to various specific example embodiments thereof, each example is provided by way of explanation, not limitation of the disclosure. Those skilled in the art, upon attaining an understanding of the foregoing, may readily produce alterations to, variations of, and/or equivalents to such embodiments. Accordingly, the subject disclosure does not preclude inclusion of such modifications, variations, and/or additions to the present subject matter as would be readily apparent to one of ordinary skill in the art. For instance, features illustrated and/or described as part of one embodiment may be used with another embodiment to yield a still further embodiment. Thus, it is intended that the present disclosure cover such alterations, variations, and/or equivalents.

1. A method comprising:
receiving, by one or more computing devices, data indicating a hyperlinked object invoked by a user in response to the hyperlinked object being provided to the user as part of a plurality of search results determined to be responsive to a query of the user;
determining, by the one or more computing devices and based at least in part on one or more machine learning (ML) models and the data indicating the hyperlinked object, at least one of a subjective intent or sentiment of the user associated with the query; and
responsive to determining, by the one or more computing devices, that the at least one of the subjective intent or sentiment of the user corresponds to a subjective intent or sentiment designated by a content supervisor of the user for identification, generating, by the one or more computing devices, data representing a graphical user interface (GUI) indicating detection of the at least one of the subjective intent or sentiment of the user and comprising educational material counseling the user with respect to the at least one of the subjective intent or sentiment.

2. The method of claim 1, wherein the hyperlinked object comprises a title of a linked webpage.

3. The method of claim 1, wherein the hyperlinked object comprises at least one of a hashtag or caption associated with one or more images or videos.

4. The method of claim 1, wherein determining the at least one of the subjective intent or sentiment comprises determining the at least one of the subjective intent or sentiment based at least in part on a history of one or more hyperlinked objects previously invoked by the user.

5. The method of claim 1, wherein determining the at least one of the subjective intent or sentiment comprises determining the at least one of the subjective intent or sentiment based at least in part on a history of one or more intents or sentiments of the user previously determined based at least in part on the one or more ML models.

6. The method of claim 1, wherein:
determining the at least one of the subjective intent or sentiment comprises determining the at least one of the subjective intent or sentiment from amongst a plurality of predetermined different and distinct possible intents or sentiments designated by the content supervisor of the user for identification;
the one or more ML models comprise at least one common ML model configured to determine multiple different and distinct intents or sentiments from amongst the plurality of predetermined different and distinct possible intents or sentiments; and
determining the at least one of the subjective intent or sentiment of the user comprises determining, from amongst the plurality of predetermined different and distinct possible intents or sentiments, the at least one of the subjective intent or sentiment of the user based at least in part on the at least one common ML model.

7. The method of claim 1, wherein:
determining the at least one of the subjective intent or sentiment comprises determining the at least one of the subjective intent or sentiment from amongst a plurality of predetermined different and distinct possible intents or sentiments designated by the content supervisor of the user for identification;
the one or more ML models comprise multiple different and distinct ML models, each of which is configured to determine a different and distinct intent or sentiment of the plurality of predetermined different and distinct possible intents or sentiments; and
determining the at least one of the subjective intent or sentiment of the user comprises determining, from amongst the plurality of predetermined different and distinct possible intents or sentiments, the at least one of the subjective intent or sentiment of the user based at least in part on at least one of the multiple different and distinct ML models.

8. The method of claim 1, wherein receiving the data indicating the hyperlinked object invoked by the user comprises receiving said data via a web-browser extension configured to generate the data.

9. The method of claim 1, wherein receiving the data indicating the hyperlinked object invoked by the user comprises receiving said data via code configured to generate the data and injected into intercepted network traffic associated with the plurality of search results.

10. (canceled)

11. The method of claim 1, comprising generating, by the one or more computing devices, at least one of the one or more ML models based at least in part on a corpus of training data comprising hyperlinked objects provided as part of search results determined to be responsive to one or more training queries comprising one or more parameters associated with the at least one of the subjective intent or sentiment of the user.

12. The method of claim 11, wherein at least one of the one or more parameters comprises natural language corresponding to a human inquiry objectively indicating the at least one of the subjective intent or sentiment of the user.

13-20. (Canceled)

21. A system comprising:
one or more processors; and
a memory storing instructions that when executed by the one or more processors cause the system to perform operations comprising:
receiving data indicating a hyperlinked object invoked by a user in response to the hyperlinked object being provided to the user as part of a plurality of search results determined to be responsive to a query of the user;
determining, based at least in part on one or more machine learning (ML) models and the data indicating the hyperlinked object, at least one of a subjective intent or sentiment of the user associated with the query; and
responsive to determining that the at least one of the subjective intent or sentiment of the user corresponds to a subjective intent or sentiment designated by a content supervisor of the user for identification, generating data representing a graphical user interface (GUI) indicating detection of the at least one of the subjective intent or sentiment of the user and comprising educational material counseling the user with respect to the at least one of the subjective intent or sentiment.

22. The system of claim 21, wherein the hyperlinked object comprises at least one of:
a title of a linked webpage; or a hashtag or caption associated with one or more images or videos.

23. The system of claim 21, wherein determining the at least one of the subjective intent or sentiment comprises determining the at least one of the subjective intent or sentiment based at least in part on a history of one or more hyperlinked objects previously invoked by the user.

24. The system of claim 21, wherein determining the at least one of the subjective intent or sentiment comprises determining the at least one of the subjective intent or sentiment based at least in part on a history of one or more intents or sentiments of the user previously determined based at least in part on the one or more ML models.

25. The system of claim 21, wherein receiving the data indicating the hyperlinked object invoked by the user comprises receiving said data via a web-browser extension configured to generate the data.

26. The system of claim 21, wherein receiving the data indicating the hyperlinked object invoked by the user comprises receiving said data via code configured to generate the data and injected into intercepted network traffic associated with the plurality of search results.

27. The system of claim 21, wherein the operations comprise generating at least one of the one or more ML models based at least in part on a corpus of training data comprising hyperlinked objects provided as part of search results determined to be responsive to one or more training queries comprising one or more parameters associated with the at least one of the subjective intent or sentiment of the user.

28. The system of claim 27, wherein at least one of the one or more parameters comprises natural language corresponding to a human inquiry objectively indicating the at least one of the subjective intent or sentiment of the user.

29. One or more non-transitory computer-readable media comprising instructions that when executed by one or more computing devices cause the one or more computing devices to perform operations comprising:
receiving data indicating a hyperlinked object invoked by a user in response to the hyperlinked object being provided to the user as part of a plurality of search results determined to be responsive to a query of the user;
determining, based at least in part on one or more machine learning (ML) models and the data indicating the hyperlinked object, at least one of a subjective intent or sentiment of the user associated with the query; and
responsive to determining that the at least one of the subjective intent or sentiment of the user corresponds to a subjective intent or sentiment designated by a content supervisor of the user for identification, generating data representing a graphical user interface (GUI) indicating detection of the at least one of the subjective intent or sentiment of the user and comprising educational material counseling the user with respect to the at least one of the subjective intent or sentiment.
